(19) United States
(12) Patent Application Publication
(10) Pub. No.: US 2007/0265873 A1
(43) Pub. Date: Nov. 15, 2007

(54) METHOD AND SYSTEM FOR ONLINE CUSTOMER RELATIONSHIP MANAGEMENT

(76) Inventors: Urvashi SHETH, South San Francisco, CA (US); Anthony Fedanzo, Corte Madera, CA (US)

Correspondence Address: EVERGREEN VALLEY LAW GROUP, 2670 S. WHITE ROAD, SUITE 275, SAN JOSE, CA, 95148, US

(21) Appl. No.: 11/692,192

(22) Filed: Mar. 28, 2007

Related U.S. Application Data
(60) Provisional application No. 60/746,988, filed on May 11, 2006.

(51) Int. Cl. G06Q 10/00; G06Q 30/00

(52) U.S. Cl. 705/1

(57) ABSTRACT

The present invention discloses a method and system for online customer support among a plurality of organizations and customers through a service provider. One aspect of the present invention discloses a method which includes receiving a search criterion from said plurality of customers, searching for one or more organization's support and service information page of interest among the plurality of organizations in a database, database maintained by the service provider, displaying the search results, and receiving a selection of one or more organizations of interest from the displayed search results and a means of interacting with the organizations web based support and service. Another aspect of the present invention discloses a system including a user interface, a multimodal search engine and a means for enabling interactive communications with selected organization's customer service department. The present invention provides a one-click access to the support channel of the organizations through a single portal. Hence, customers obtain efficient and quick support services from the organizations.

### PRIORITY CLAIM

This application claims the benefit of Provisional Patent Application No. 60/746,988 filed May 11, 2006, which is incorporated herein by reference.

### BACKGROUND OF THE INVENTION

1. Field of the Invention

The present invention generally relates to customer relationship management (CRM) and more specifically to a method and a system for online customer support among a plurality of organizations and customers through a service provider.

2. Description of Related Art

Providing customer support by responding and answering potential, new, or existing customer questions are among the most vital functions for any company in any industry. Historically, support channels are person-to-person interactions built around telephone call centers and email. With the instant messaging revolution, some companies have been savvy enough to integrate instant messaging (IM) based services like “click to chat” type of access on their website. IM gives customers immediate access to support personnel during typical web site activities like buying and researching products or services.

Consumers today are accustomed to using desktop, laptop and handheld computers to perform business related activities. As more tasks can be performed on these web-connected devices, support for consumers should be getting easier and more efficient. Yet many consumers know that this is not so. The same thing may be said of companies, namely, that technology should be leading to cheaper and more effective customer support services. The reality is much different because corporate labor costs to recruit and retain employees possessing great interpersonal and language skills, as well as in-depth product knowledge have become almost prohibitively expensive.

The approaches adopted by the organizations worldwide for providing various support channels of help to the customers has not proved to be effective and in many cases they are very expensive. Providing customers with contact details like corporate email address, website and telephone number is no longer adequate. In many cases accurate and relevant information is not available to the customers immediately by using the above means.

Serving customers in a timely fashion is a key to customer retention and satisfaction. Absence of proper and adequate information and services results in loss of loyal as well as new customers. With existing support or response methods, the dissatisfaction rate of customers is as high as 22%. These problems results into a huge communication gap between the companies and its customers. Such poor or inadequate communication results in loss of customers, impacting revenue and reputation.

In the business world the main communication channels provided by companies to their customers are email address, phone numbers and their website URL address. Many times these channels fail because they fail to solve customer problem immediately. The customer is never sure of response time of the company. This uncertainty of response causes huge amounts of frustration on customer side. On the other hand, the company has to go through various different processing and routing of one query in order to get an accurate answer for the customer.

The global companies are rapidly moving toward serving customers entirely online. e-CRM reflects a move towards strategic customer engagement as companies gain a clearer understanding of who their “high value” prospects are and how they can convert more of these prospects into customers. The different channels for e-CRM include phone and interactive voice response (IVR) and website etc.

In phone based CRM, queuing of calls due to high call volumes results in high wait time for customers which, in turn, increase overall customer dissatisfaction. Once past the welcome message, callers on average hang up after just 65 seconds of listening to canned music. Poor customer service and call handling skills increase customer attrition. Operators located overseas who are working from scripts often have trouble with language and accent problems, thereby increasing customer dissatisfaction.

In website based CRM, there is a “Contact Us” link on every website where the user could find online support. This button does not provide satisfactory information to the customers. Queries made by a submission form go unanswered for a long time. Phone numbers provided on websites involve a lot of department hopping, and place customers into IVR or on hold. Most sites lack a simple navigation tree and sensitive search engine and when a search engine is available, results often lack a high degree of relevancy. And, there is no option to reach a representative by chat or messenger on most web sites. It takes an average of three or more attempts to reach information on the “contact us” page. The result is a higher degree of customer dissatisfaction.

Hence there exists a need for a method and system for an effective CRM and to get the customers questions answered quickly and efficiently. The objective of the present invention is to provide customers with accurate information immediately with options to choose the appropriate channel of communication.

### SUMMARY OF THE INVENTION

The present invention is intended to solve the problem as referred to above, and has as its object to provide a method and system for easy access to service, sales, support or other information channels of organizations through a service provider.

The multi modal presence based search engine as described in the invention is specifically designed for locating and retrieving and presenting presence based and related information. Using the multi-modal presence based search engine, users can find an organization's support and services related information such as telephone numbers, postal address, fax numbers, email address, uniform resource locator (URL), map, driving directions, etc. The user also has an option to use an organization's presence based communication channel to contact the organization's support or service department from within the service provider's website. The channels provide for interaction include presence based chat, voice over internet protocol (VOIP) and ability to email a query. Features available to the organization include monitoring of their customer's behavior, conferencing, real time reporting and analysis, notification of chat request to their agents, offline message facility, co-browsing and predefined responses feature. These features are explained in the detailed description section.

One aspect of the present invention provides a method for online customer support where the service provider performs the steps which include receiving a search criterion from said plurality of customers, searching for one or more organization's support and service information page of interest among the plurality of organizations in a database, database maintained by the service provider, displaying the search results, and receiving a selection of one or more organizations of interest from the displayed search results and a means of interacting with the organizations web based support and service.

Another aspect of the present invention provides a system for online customer support that includes a user interface for said customers to interact with the service provider's presence enabled portal, a multimodal search engine for searching at least one of the organization's support and service information page in a database maintained by the service provider, and a communication module for enabling interactive communications with selected organization's customer service department. The system also includes a user input module for receiving and processing the search criterion from the customers and a display module for displaying the search results to the customers.

Another aspect of the present invention provides a method for finding online presence based customer support among a plurality of organizations through a service provider, where customers of the organization, perform steps which include logging into the service provider's presence enabled portal for searching for at least one of the organization's support and service information page, inputting a search criterion including a plurality of search elements for searching in a database maintained by the service provider, selecting the required information from a set of displayed results which includes organization's support and service information page on the service provider's presence enabled portal and selecting a means of interacting with the organization's support and service department from the set of displayed results.

One advantage of the present invention is that it enables a customer to find the services or goods they are looking for and engage in interactive dialog directly with potential providers of the services or goods. The benefit of searching and directly contacting organizational presence based communication channels creates very high customer satisfaction since, searching, entering data, getting irrelevant response and then calling and waiting in the phone queue is not needed. A user can select their preferred communication channel (like instant messaging (IM), electronic mail and VOIP enabled telephone conversation) to interact with the organization from the same website.

Another advantage of the present invention is that the pages and the customer activities causing the highest levels of site abandonment are identified. For example, organizations need to know whether most of their customers leave their web site's purchase completion page when the customer is not able to get appropriate customer support to close the purchase.

Another advantage of the present invention is that the contextual information from a customer's chat session to the call center agent ensures a smooth customer transition from chat to voice channel. Customers do not have to start the transaction again with an agent when they switch to VOIP based conversation. Agent-initiated escalation from text chat to live voice communication will offer value far beyond a traditional inbound phone call. This will provide a complete set of capabilities to fully integrate the online and voice channels.

Another advantage of the present invention is, it provides customer purchasing/life-time value information such as visitors log, hits count, daily unique and monthly unique counts. Detailed log of visitors and their referrer, URL accessed time zone, time and IP address etc. Logs will be recorded and maintained for the organization's future reference.

Another advantage of the present invention is that organizations are able to bid for their presence based page or pages to be displayed with higher priority to customers searching for products or services. Hence, the method and system of the present invention enables high value marketing and advertising opportunities to organizations, thereby cutting down the marketing costs and increasing the return on investment.

The above summary of the present invention is not intended to describe each disclosed embodiment of the present invention. The figures and detailed description that follow provide additional aspects of the present invention.

### BRIEF DESCRIPTION OF DRAWINGS

The foregoing and other features, aspects and advantages of the present invention are described in detail below in connection with the accompanying drawings. The drawings comprise 6 figures in which,

FIG. 1 is a flow diagram illustrating an embodiment of the method of users searching for an organization's support and service page.

FIG. 2 is a screen shot displaying a search page on the service provider's website and a user entering the search elements.

FIG. 3 is another screen shot displaying the search results on the service provider's website.

FIG. 4 is another screen shot displaying the interactive communication of the user with an organization's support services through a chat option.

FIG. 5 is another screen shot displaying the pre-defined categories available for the users while search.

FIG. 6 is a flow diagram of the search method for populating a database with presence enabled communication channel links.

FIG. 7 is a flow diagram illustrating the steps performed by the service provider in the method for providing online customer support according to an embodiment of the present invention.

FIG. 8 is a block diagram illustrating the system architecture for online customer support among a plurality of organizations and customers through a service provider according to an embodiment of the present invention.

### DETAILED DESCRIPTION OF DRAWINGS

In the following description, numerous specific details are set forth in order to provide a more thorough understanding of the present invention. However, it will be apparent to one skilled in the art that the present invention may be practiced without these specific details. In other instances, well-known features have not been described in detail in order to avoid obscuring the present invention.

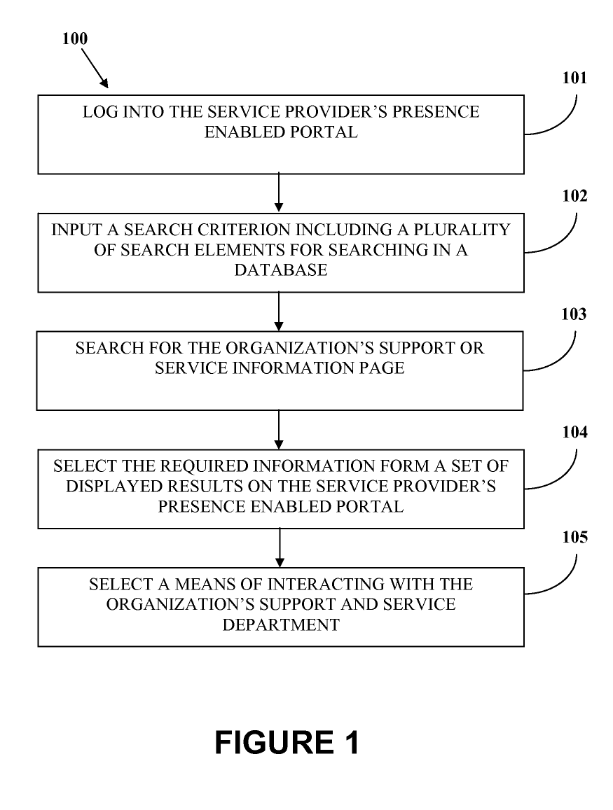

FIG. 1 is a flow diagram illustrating an embodiment of the method 100 of users searching for an organization's support and service page. Step 101 logs into the service provider's presence enabled portal where the users can search for an organization's support and services information pages. Step 102 inputs a search criterion including a plurality of search elements. In step 102, the user interface prompts the user to enter a keyword or a business name and/or location. Alternatively, users can also search predefined business categories. These business categories will have its sub-categories. A user can also search by a category and narrow the search by location. Step 103 searches for the organization's support or service information page.

By clicking the search option, the user will be presented with the list of companies and information such as “Click to Chat” URL, mailing address, fax number, email address and web site URL address. Step 104 selects the required information from the displayed search results on the service provider's presence enabled portal. Step 105 selects means of interacting with organization's support and service department. The various communication channels available for the users include instant messaging, voice over internet protocol and electronic mail. Users can place a call from the website to speak to company's service representative using VOIP channel. The users click on the icon on the website to chat with the support representatives in real-time. No plug-ins or downloads are required for website users.

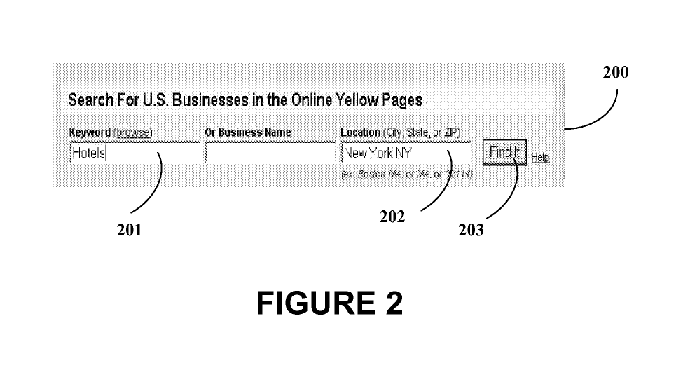

FIG. 2 is a screen shot displaying a search page on the service provider's website and a user entering the search elements 200. Considering an example in which the user wants to find out information about hotels in New York. User enters the key word ‘Hotels’ 201 and the location as ‘New York’ 202. Clicking on ‘Find It’ 203 displays all the presence enabled pages (according to highest bidders displayed in first five) for the user to click on. User will have choice to select their preferred channel of communication i.e. chat, VOIP and email to interact with the company's customer service department.

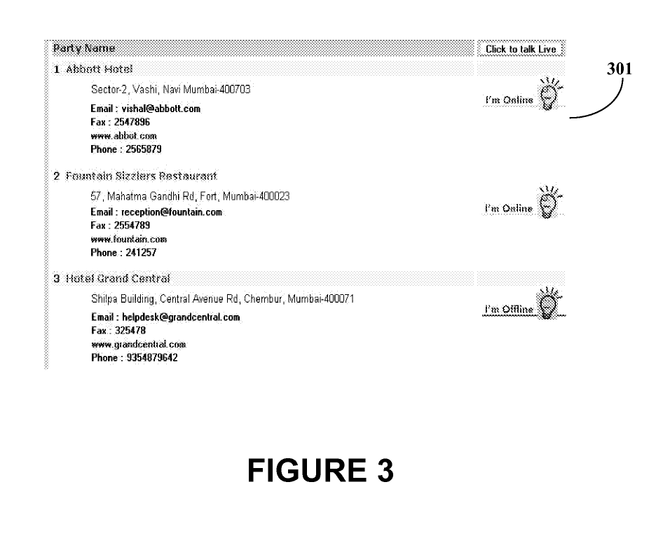

FIG. 3 is another screen shot displaying the search results on the service provider's website 301. The result page on the service provider's website will be as displayed in FIG. 3. The displayed results include all the presence enabled pages (according to the highest bidders displayed in first five) for the users to click on. Under each organization, the contact information of the organization including e-mail, fax number, phone number and URL address is displayed. The users click on any one of the displayed items to select how they would like to interact with the company's service or support representative. Also, the result page shows whether the displayed organizations are online.

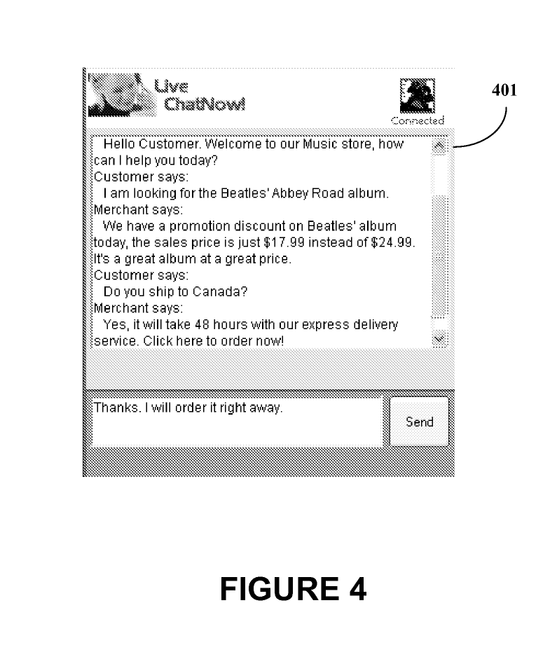

FIG. 4 is another screen shot displaying the interactive communication of the user with an organization's support services through a chat option 401. Consider a situation where a user selects the chat option to interact with the organization. The chat option functions like any other chat window and the user gets immediate response to their queries that leads to greater customer satisfaction. VOIP option is integrated inside the chat window. Even if the user chooses the chat option, they always get an option to get connected to speak to service or support representative through the VOIP option from the same chat window.

The chat window will provide an icon to start a phone conversation at any time within the chat session. This will allow the customer to escalate a text chat to a voice channel whenever desired. Agent-initiated escalation from text chat to live voice communication will offer value far beyond a traditional inbound phone call. This will provide a set of capabilities to integrate the online and voice channels. Also, when the chat option is selected as a channel of communication by the user, an organization's support representative can handle more than one chat at a time, and agents can invite other agents into their chat for online specialized support or advice. If a user requests to chat, then notification such as a ring sound or popup of the monitoring window, notifies the agent immediately about the user's chat request. In case support representatives are offline or the request is after their normal business hours an offline/leave message graphic will be displayed on the website.

Additionally, the agent and the customer will be able to co-browse company's website or other important decision points feature. For example, an agent assisting a user in buying an air ticket can enable co-browse to better help user select a seat from the aircraft's seating chart, or book a table in the restaurant by co-browsing the restaurant seating arrangements.

While on chat, companies will be able to advertise their new or otherwise relevant products to users. For example, if a user is chatting about plane tickets to Hawaii, a full vacation package of Hawaii can be advertised at that point and prompt the user to ask about this package to get more discounts. This option provides high-value marketing and advertising opportunities to the organization and reduces their marketing and advertising costs.

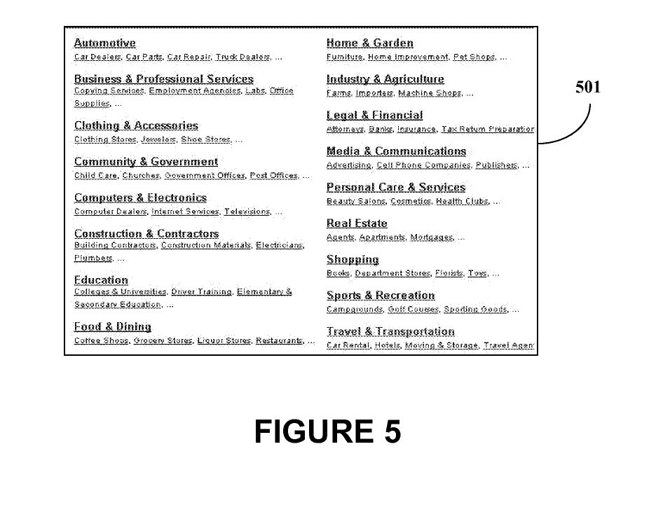

FIG. 5 is another screen shot displaying the predefined categories available for the users while searching 501. There are predefined business categories available for the users to search. These business categories have sub-categories. A user can also search by a category and narrow down the search by location. For example, if a user clicks on the category “Travel & Transportation” or the sub category “Hotels,” the user will be prompted to enter the location for the same. After user enters the location, the search engine will display presence enabled pages as shown above for the user to click and interact with company's service or support representatives.

Consider another example where a customer wants to contact an airline support representative from where they have bought the air ticket. For this search, the customer enters the name of the airline. The entire airline's presence enabled chat pages will be displayed as, for example reservation, mileage redemption, vacation packages and other inquiries etc. Customer then selects the appropriate page and contacts the airline using preferred channel.

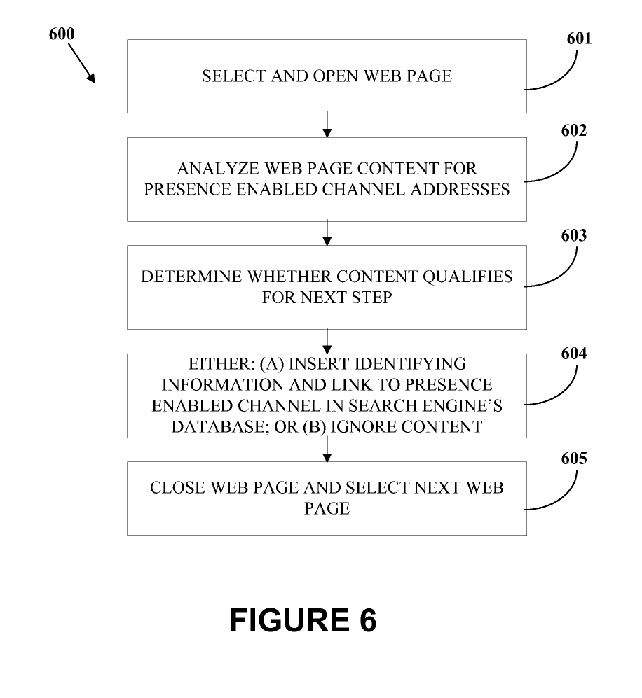

FIG. 6 is a flow diagram 600 illustrating how the database supporting the multi modal presence enabled search engine is populated with data obtained from automated or manual processes that specifically select only presence based communication channels from available web pages searched.

Using an iterative process, individual web pages being searched for presence based communications channels are opened 601 and their contents analyzed 602 to determine whether they contain a link to a presence enabled communication channel 603. If the link is found, then the link and relevant identifying information is inserted into the database 604 and the next available web page is selected 605.

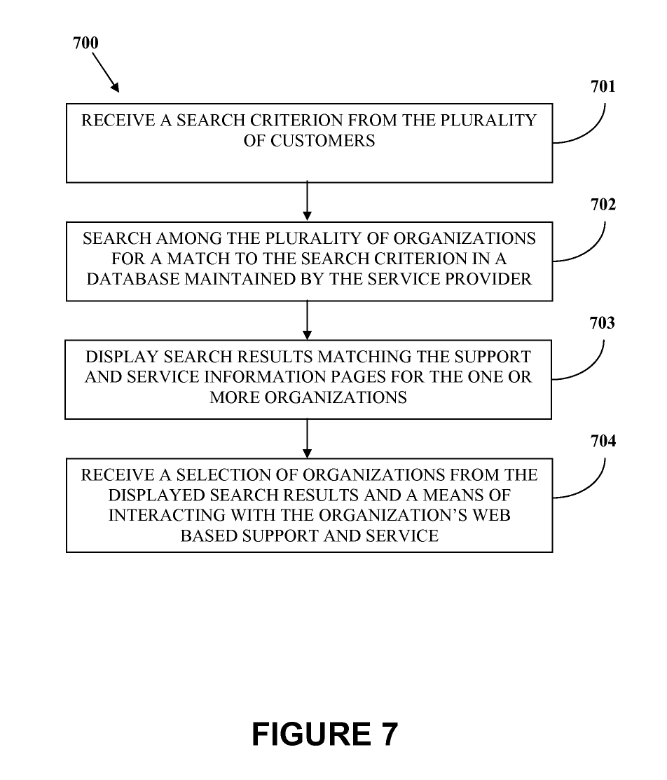

FIG. 7 is a flow diagram illustrating the steps performed by the service provider in the method for providing online customer support according to an embodiment 700 of the present invention. Step 701 receives a search criterion from the plurality of customers. Through an interactive user interface customers can access and interact with the service provider's presence enabled portal. Step 702 searches the organization's support and service information pages among the plurality of organizations in a database for a match to the search criterion. This database maintained by the service provider and is populated with data as explained in FIG. 6.

Step 703 displays search results matching the support and service information pages for the one or more organizations to the customer. Customer selects the required organization from the displayed results and also selects a means of interacting with organization's web based support and service. Step 704 receives the selected organizations and selected means of interacting, and enables the interaction between the customer and organization's web based support and service. The various communication channels available for interaction between the customer and organization's web based support and service instant messaging, voice over internet protocol and electronic mail. Users can place a call from the website to speak to company's service representative using VOIP channel.

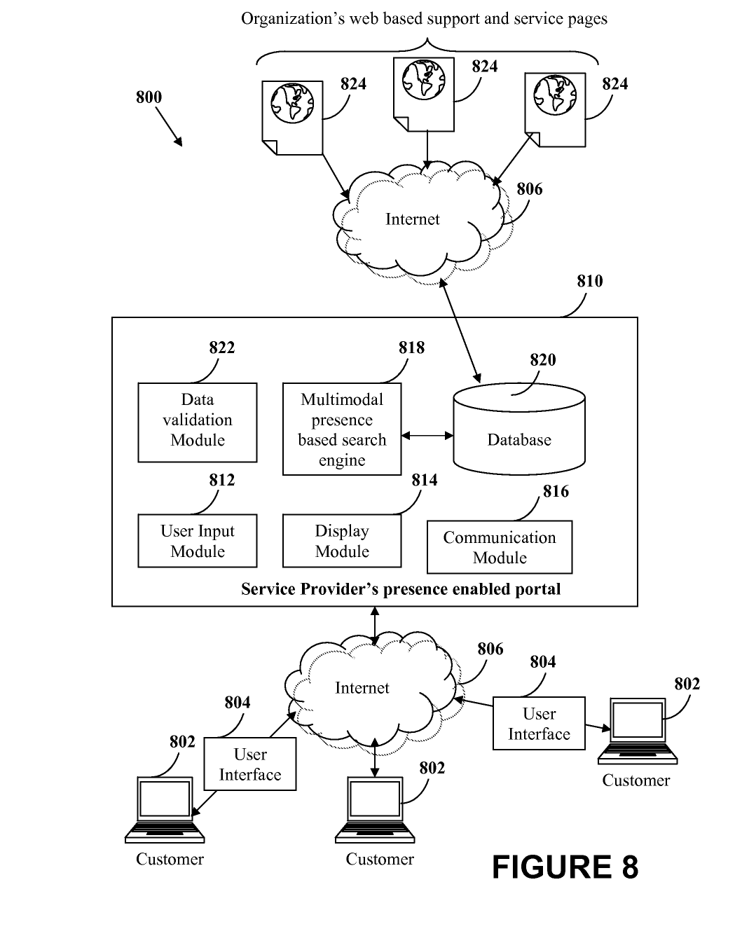

FIG. 8 is a block diagram illustrating the system architecture for online customer support among a plurality of organizations and customers through a service provider according to an embodiment of the present invention 800. The service provider's presence enabled portal 810 includes a communication module 816, a display module 814, a user input module 812, a data validation module 822, a multi modal presence based search engine 818, and a database 820. Customers 802 access the service provider's presence enabled portal 810 through their communication devices connected via internet 806. An interactive user interface 804 is provided to access the service provider's presence enabled portal 810. The user input module 812 receives the search criterion form the customers 802. The multi modal presence based search engine 818 searches the database 820 for matching results. The database 820 includes the information about the organization's web based support and service pages 824. The data stored in the database 820 is validated through the data validation module 822.

The display module 814 displays the search results to the customers 802. Customers can select required organization from the displayed search results and also can select a means of interacting with organization's web based support and service. If the customers 802 choose to communicate with the organizations web based support and service, the communication module 816 enables the communication channel.

The forgoing description sets forth numerous specific details to convey a thorough understanding of the invention. However, it will be apparent to one skilled in the art that the invention may be practiced without these specific details. Well-known features are sometimes not described in detail in order to avoid obscuring the invention. Other variations and embodiments are possible in light of above teachings, and it is thus intended that the scope of invention not be limited by this Detailed Description, but only by the following claims.

1. A method for locating and connecting to an organization's support and service information page among a plurality of organizations and a plurality of customers through a service provider, said service provider performing the steps of:
receiving a search criterion from said plurality of customers;
searching one or more organization's said support and service information pages among the plurality of organizations in a database for a match to said search criterion, said database maintained by the service provider;
displaying search results matching said support and service information pages for the one or more organizations; and
receiving a selection of said one or more organizations from the displayed search results and a means of interacting with the organization's web based support and service.

2. The method of claim 1, wherein said means of interacting comprises instant messaging, voice over internet protocol enabled telephone services and electronic mail, said instant messaging further comprises speaking through said voice over internet protocol.

3. The method of claim 1, wherein said displayed results comprises displaying the web based support and service information pages of highest bidding organizations with the service provider.

4. The method of claim 1, wherein said database comprises information about the organizations having a web based support and service information page.

5. A method for locating and connecting to online customer support among a plurality of organizations and customers through a service provider, wherein said customers perform the steps of:
logging into said service provider's presence enabled portal for searching at least one of said organization's support and service information page.
inputting a search criterion for searching the at least one of said organization's support and service information page, wherein a set of results of the search is displayed;
selecting the required information from the set of displayed results on the service provider's presence enabled portal; and
selecting a means for interacting with the organization's support and service department from said set of displayed results.

6. The method as in claim 5, wherein said searching at least one of said organization's support and service information page comprises searching in predefined business categories, said business categories further comprise sub-categories.

7. The method as in claim 5, wherein said inputting a search criterion comprises entering keywords and searching in predefined categories.

8. The method as in claim 5, wherein said selecting a means of interacting comprises selecting from instant messaging, voice over internet protocol enabled telephone services and electronic mail, said instant messaging further comprises a choice to get connected to speak through said voice over internet protocol.

9. The method as in claim 5, wherein said database comprises information about the organizations having a web based support and service information page.

10. A system for online customer support among a plurality of organizations and customers through a service provider comprising:
a user interface for said customers to interact with said service provider's presence enabled portal through a communication network;
multimodal search engine for searching at least one of said organization's support and service information page in a database maintained by the service provider; and
a communication module for enabling interactive communications with selected organization's web based support and service.

11. The system as in claim 10 further comprising:
a user input module for receiving and processing a search criterion including a plurality of search elements from the customers;
a data validation module for validating data stored in said database; and
a display module for displaying search results to the customers.

12. The method of claim 11, wherein the database comprises information about the organizations having a web based support and service information page.
